(19) United States
(12) Patent Application Publication
(10) Pub. No.: US 2013/0144723 A1
(43) Pub. Date: Jun. 6, 2013

(54) SYSTEMS, METHODS AND ARTICLES TO AUTOMATICALLY EXPOSE AND PLACE MATERIAL IN STREAMS OF PROGRAMMING

(71) Applicant: Abacast, Inc., Vancouver, WA (US)

(72) Inventors: Robert D. Green, Seattle, WA (US); James M. Kott, Kirkland, WA (US); John W. Morris, IV, Washougal, WA (US); Nils Lahr, Snoqualmie, WA (US)

(73) Assignee: ABACAST, INC., Vancouver, WA (US)

(21) Appl. No.: 13/679,828

(22) Filed: Nov. 16, 2012

Related U.S. Application Data
(60) Provisional application No. 61/561,186, filed on Nov. 17, 2011.

(51) Int. Cl. G06Q 30/02

(52) U.S. Cl. CPC G06Q 30/0277
USPC 705/14.61; 705/14.73; 705/14.69

(57) ABSTRACT

Content providers or media outlets may provide opportunities to place insertion or replacement material, for example, advertisements, into alternate streams or feeds of programming. A clearinghouse of such for various content providers may be automatically maintained and updated. Entities with insertion or replacement material may reserve, bid on or automatically place insertion or replacement material. An insertion system component may automatically insert material in an alternative feed of programming, for example, automatically replacing locally relevant advertisement in a broadcast with more general or even more specific advertisements in a Web feed of the programming. Organization of the insertions or replacement may be automatically determined based on various criteria.

### BACKGROUND

1. Field

This disclosure generally relates to automated insertion of material into streams of information, for example, insertion of advertisements into Webcasts or other streams of information.

2. Description of the Related Art

Content providers such as radio stations and networks, television stations and networks, and Webcasters provide programming including content which is the subject of programming. Content providers' delivery of content is often via broadcasts or Webcasts. While content providers may employ repeaters and the like, broadcasts are typically limited in range to a geographic region.

Programming often includes advertisements interspersed with the subject matter of the programming. The advertisements may occur in segments sometimes referred to as “ad breaks.” Content providers typically sell advertising time to generate revenue to fund operation, as well as generate profits, where the content provider is a commercial entity rather than a nonprofit entity. Given that most broadcasts are local in nature or extent, content providers often carry advertisements and other material which is of a somewhat local or parochial interest. For example, a local chain may place advertisements with a local broadcaster since the audience targeted by the local chain is also often local and local advertising tends to be less expensive than regional or national advertising.

Often, content providers provide an alternative source of the programming, for example, providing a Webcast or even a podcast of the programming. The audience for the alternative source of programming may be significantly different from the audience for the broadcast. For example, the audience for the alternative source of programming may be more geographically diverse, or may be more comfortable with technologies such as streaming of content to desktop computers or even Smartphone devices. As such, the advertisements interspersed in a broadcast may not be particularly well suited, applicable or of interest to the audience of the alternative source of programming.

New approaches that automate the various activities related to placement of new materials, for instance, advertisements, in alternative programming streams are desirable.

### BRIEF SUMMARY

An automation placement system to automate advertisement placement in broadcasts or Webcasts may be summarized as including at least one nontransitory computer-readable storage medium that stores an inventory of advertisement placement opportunities to place advertisements in at least one of a number of broadcasts or a number or Webcasts for each of a plurality of at least one of broadcast or Webcast content providers that transmit the broadcasts or the Webcasts, respectively; and at least one processor communicatively coupled to the at least one nontransitory computer-readable storage medium and which implements an interface that provides access to the inventory of advertisement placement and that updates the inventory of advertisement placement opportunities from time-to-time to reflect advertisement placement opportunities no longer available and new advertisement placement opportunities that are available, the at least one processor further communicatively coupled to cause a number of advertisement insertion components to insert a number of advertisements into a Web streaming of at least one of the terrestrial broadcasts or the Webcast of the at least one broadcast or Webcast content provider during the terrestrial broadcast or the Webcast.

The inventory of advertisement placement opportunities to place advertisements stored by the at least one nontransitory computer-readable medium may include, for each of at least some of the advertisement placement opportunities, an indication of whether the respective advertisement placement opportunity is a guaranteed placement opportunity for a defined advertisement network, where each guaranteed placement opportunity for an advertisement ensures that the advertisement network has an exclusive right for the respective advertisement placement opportunity from the at least one broadcast or Webcast content provider. The inventory of advertisement placement opportunities to place advertisements stored by the at least one nontransitory computer-readable medium may include, for each of at least some of the advertisement placement opportunities, an indication of whether the respective advertisement placement opportunity is a nonguaranteed placement opportunity, where each nonguaranteed placement opportunity for an advertisement available from at least one source other than the defined advertisement network. The at least one processor may identify a number of the advertisement placement opportunities to place advertisements as guaranteed placement opportunities, in response to receipt of a signal from one of the broadcast or Webcast content providers that includes an indication of a percentage of a total amount of advertisement placement opportunities offered by the respective broadcast or Webcast content provider which the respective broadcast or Webcast content provider guarantees to a defined advertisement network as available for placement thereby via the automation placement system. The at least one processor may limit a total number of the advertisement placement opportunities to place advertisements offered via the automation placement system, in response to receipt of a signal from one of the broadcast or Webcast content providers that includes an indication of at least one of a cap to or a maximum percentage of a total amount of advertisement placement opportunities offered by the respective broadcast or Webcast content provider to a defined advertisement network. The at least one processor may provide pricing information for at least some of the advertisement placement opportunities in the inventory of advertisement placement opportunities. The at least one processor may provide at least one of general population demographic information or individual specific demographic information in conjunction with the pricing information for at least some of the advertisement placement opportunities in the inventory of advertisement placement opportunities. The at least one processor may receive multiple offers over time for at least one of the advertisement placement opportunities in the inventory of advertisement placement opportunities, before accepting one of the offers. The at least one processor may receive multiple offers from a plurality of advertising networks over time for at least one of the advertisement placement opportunities in the inventory of advertisement placement opportunities, before accepting one of the offers. The at least one processor may provide the pricing information for at least some of the advertisement placement opportunities in the inventory of advertisement placement opportunities in the form of a current offer price and a guaranteed purchase price which guarantees the respective advertisement placement opportunity. The at least one processor may provide the pricing information for at least some of the advertisement placement opportunities in the inventory of advertisement placement opportunities in the form of a dynamically adjusted price that is based on at least one external condition or event. The at least one processor may provide at least one of general population demographic information or individual specific demographic information for at least some of the advertisement placement opportunities in the inventory of advertisement placement opportunities. The at least one processor may provide pricing information in terms of a unit number of impressions to each of a number of advertising networks for at least some of the advertisement placement opportunities in the inventory of advertisement placement opportunities which exceed an amount of advertisement placement opportunities that is directly allocated for placement solely via the automation placement system by respective ones of the broadcast or Webcast content providers. For each of at least some of the advertisement placement opportunities in one of the broadcasts or Webcasts, the at least one processor may determine which of a plurality of advertisements to place in each of a plurality of the advertising opportunities based at least in part on a monetary value realizable by the placements of the advertisements. Each of at least some of the advertisement placement opportunities may be respective ones of a number of commercial breaks in a Web streaming of a terrestrial broadcast, and the at least one processor may determine which of a plurality of advertisements to place in the commercial breaks in the Web streaming. The at least one processor may determine which of a plurality of advertisements to place in the commercial breaks in the Web streaming based at least in part on a monetary value of the advertisement placements. The at least one processor may determine to place a first number of relatively short advertisements in one of the commercial breaks in the Web streaming, and the first number may be larger than a number of advertisements in the same one of the commercial breaks in the terrestrial broadcast. The automation placement system may further include at least one of the advertisement insertion components, each of the at least one of the advertisement insertion components including at least one nontransitory processor-readable storage and at least one insertion component processor communicatively coupled to the at least one nontransitory processor-readable medium, and which inserts advertisements into the Web streaming of the terrestrial broadcast of the broadcast content provider which is substantially concurrent with the terrestrial broadcast. The at least one processor may prioritize advertisements based on a prioritization schedule which at least partially accounts for revenue generation.

A method of operating an automation placement system to automate advertisement placement in broadcasts or Webcasts may be summarized as including storing to at least one nontransitory computer-readable storage medium an inventory of advertisement placement opportunities to place advertisements in at least one of a number of broadcasts or a number of Webcasts for each of a plurality of at least one of broadcast or Webcast content providers that transmit the broadcasts or the Webcasts, respectively; and providing an interface by at least one processor that provides access to the inventory of advertisement placement; updating the inventory of advertisement placement opportunities from time-to-time by the at least one processor to reflect advertisement placement opportunities no longer available and new advertisement placement opportunities that are available; and sending at least one signal that causes at least one of a number of advertisement insertion components to insert a number of advertisements into a Web streaming of at least one of the broadcasts or the Webcasts of the at least one broadcast or Webcast content provider during the broadcast or the Webcast.

Storing the inventory of advertisement placement opportunities to place advertisements to the at least one nontransitory computer-readable medium may include, for each of at least some of the advertisement placement opportunities, storing an indication of whether the respective advertisement placement opportunity is a guaranteed placement opportunity for a defined advertisement network, where each guaranteed placement opportunity is allocated solely to the defined advertisement network for offer thereby to a plurality of potential advertisers. Storing the inventory of advertisement placement opportunities to place advertisements to the at least one nontransitory computer-readable medium may include, for each of at least some of the advertisement placement opportunities, storing an indication of whether the respective advertisement placement opportunity is a nonguaranteed placement opportunity, where each nonguaranteed placement opportunity for an advertisement indicates that the respective advertisement placement opportunity is available from at least one source in addition to the defined advertisement network. The method may further include receiving a signal from one of the broadcast or Webcast content providers by the at least one processor, that includes an indication of a percentage of a total amount of advertisement placement opportunities offered by the respective broadcast or Webcast content provider which the respective broadcast or Webcast content provider guarantees to a defined advertisement network as available for placement thereby via the automation placement system; and identifying as guaranteed placement opportunities by the at least one processor, a number of the advertisement placement opportunities to place advertisements in response to the received signal. The method may further include in response to receipt of a signal from one of the broadcast or Webcast content providers that includes an indication of at least one of a cap to or a maximum percentage of a total amount of advertisement placement opportunities offered by the respective broadcast or Webcast content provider, limiting by the at least one processor a total number of the advertisement placement opportunities to place advertisements offered to a defined advertisement network. The method may further include providing pricing information to the at least one processor for at least some of the advertisement placement opportunities in the inventory of advertisement placement opportunities. The method may further include providing at least one of general demographic information or individual specific demographic information in conjunction with the pricing information for at least some of the advertisement placement opportunities in the inventory of advertisement placement opportunities. The method may further include receiving by the at least one processor multiple offers over time for at least one of the advertisement placement opportunities in the inventory of advertisement placement opportunities, before accepting one of the offers. The method may further include receiving by the at least one processor multiple offers from a plurality of advertising networks over time for at least one of the advertisement placement opportunities in the inventory of advertisement placement opportunities, before accepting one of the offers. Providing pricing information for at least some of the advertisement placement opportunities in the inventory of advertisement placement opportunities may include providing a current offer price and a guaranteed purchase price which guarantees the respective advertisement placement opportunity. Providing pricing information for at least some of the advertisement placement opportunities in the inventory of advertisement placement opportunities may include dynamically providing the pricing information in the form of a dynamically adjusted price that is based on actual or a predicted occurrence of at least one external condition or event. The at least one processor may provide at least one of general population demographic information or individual specific demographic information for at least some of the advertisement placement opportunities in the inventory of advertisement placement opportunities. The method may further include providing by the at least one processor pricing information in terms of a unit number of impressions to each of a number of advertising networks for at least some of the advertisement placement opportunities in the inventory of advertisement placement opportunities which exceed an amount of advertisement placement opportunities that is directly allocated for placement solely via the method by respective ones of the broadcast or Webcast content providers. The method may further include for each of at least some of the advertisement placement opportunities in one of the broadcasts or Webcasts, determining by the at least one processor which of a plurality of advertisements to place in each of a plurality of the advertising opportunities based at least in part on a monetary value realizable by the placements of the advertisements. Each of at least some of the advertisement placement opportunities may be respective ones of a number of commercial breaks in a Web streaming of a terrestrial broadcast, and may further include determining by the at least one processor which of a plurality of advertisements to place in the commercial breaks in the Web streaming. Determining which of a plurality of advertisements to place in the commercial breaks in the Web streaming may include determining which of the plurality of advertisements to place in the commercial breaks in the Web streaming based at least in part on a monetary value of the advertisement placements. Determining which of a plurality of advertisements to place in the commercial breaks in the Web streaming may include determining to place a first number of relatively short advertisements in one of the commercial breaks in the Web streaming, and the first number may be larger than a number of advertisements in the same one of the commercial breaks in the terrestrial broadcast. The method may further include inserting advertisements by at least one of the advertisement insertion components into at least one Web streaming of a terrestrial broadcast of a broadcast content provider substantially concurrently with the terrestrial broadcast.

The method may further include prioritizing a number of the advertisements based on a prioritization schedule which at least partially accounts for an identity of an entity through which an offer for a respective one of the advertisement placement opportunities was generated. The method may further include replacing an advertising opportunity in a first one of the broadcasts or the Webcasts with a first advertisement in a first Web streaming of the content of the first one of the broadcasts or the Webcasts to a first recipient; and replacing the advertising opportunity in the first one of the broadcasts or the Webcasts with a second advertisement in the first Web streaming of the content of the first one of the broadcasts or the Webcasts to a second recipient, the second advertisement different from the first advertisement.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram of a networked environment, including a number of advertising network server computer systems communicatively coupled between content providers, such as terrestrial radio or television providers or Webcasters, and advertisers who have advertisements to place or who otherwise control placement of advertisements, and also including at least one end user who receives content with inserted advertisements, according to one illustrated embodiment.

FIG. 2 is a schematic diagram of portions of the networked environment of FIG. 1, showing certain components thereof in more detail, according to one illustrated embodiment.

FIG. 3 is a schematic diagram of a material insertion system component coupled to insert material, for example, advertisements, into a stream of content provided by a content provider system, according to one illustrated embodiment.

FIG. 4A is a schematic diagram of an advertisement inventory data structure, including a number of fields to hold information related to an advertisement including an advertisement identifier, advertisement specific information, generalized population demographic information and specific individual demographic information, according to one illustrated embodiment.

FIG. 4B is a schematic diagram of an advertisement data structure, including a number of fields to hold information including an advertisement identifier and the content of the advertisement, according to one illustrated embodiment.

FIG. 5 is a schematic diagram of an advertisement placement opportunity data structure, including a number of fields to hold information related to an advertisement placement opportunity including an advertisement placement opportunity identifier, and advertisement placement opportunity specific information, according to one illustrated embodiment.

FIG. 6 is a schematic diagram an insertion component receiving original programming including segments of subject matter of the programming and segments of advertisements provided by a broadcaster or Webcaster, and providing resulting or modified programming including segments of subject matter and segments of inserted, new or replacement advertisements, according to one illustrated embodiment.

FIG. 7 shows a method of operating an advertising network server computer system, according to one illustrated embodiment.

FIG. 8 shows a method of operating an advertising network server computer system, according to one illustrated embodiment, which may be employed in performing the method of FIG. 7.

FIG. 9 shows a method of operating an advertising network server computer system, according to one illustrated embodiment, which may be employed in performing the method of FIG. 7.

FIG. 10 shows a method of operating an insertion system component to insert material into an alternate stream of programming, according to one illustrated embodiment, which may employ new or replacement advertisements identified or placed via the methods of FIGS. 7-9.

FIG. 11 shows a method of operating an advertising network server computer system or an insertion system component, according to one illustrated embodiment, which may employ prioritization to insert new or replacement advertisements identified or placed via the methods of FIGS. 7-9.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computing systems including client and server computing systems, broadcast systems including radio and television broadcast systems, as well as networks and other communications channels have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

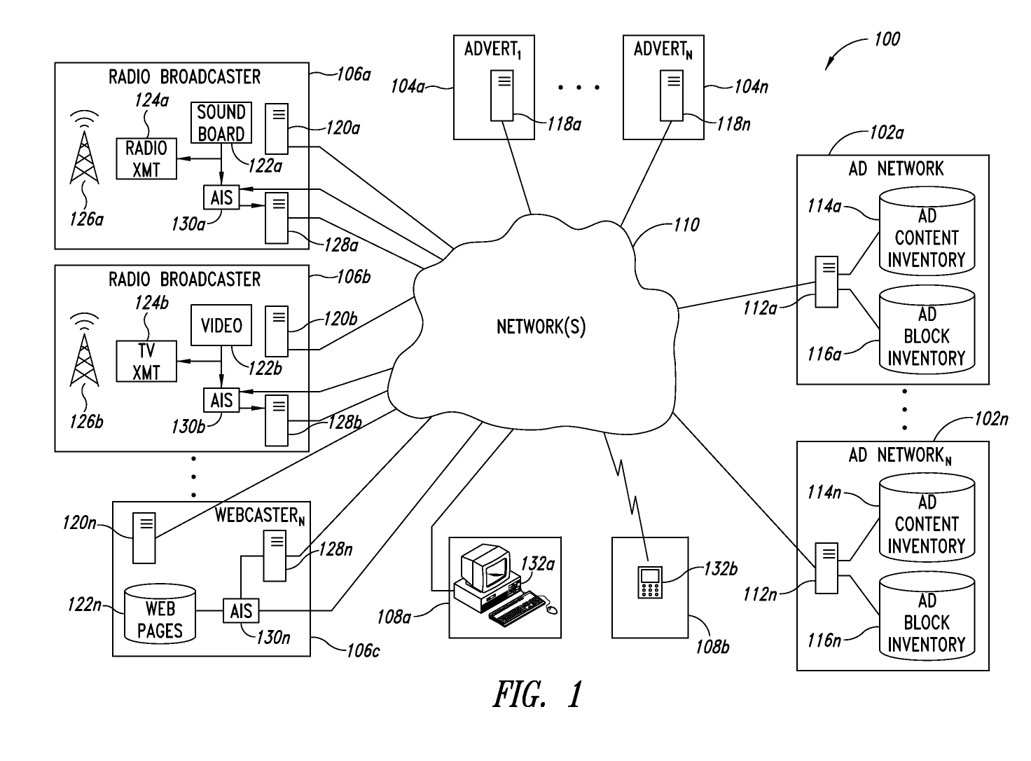

FIG. 1 shows an environment 100, according to one illustrated embodiment in which various apparatus, methods and articles described herein may operate.

The environment 100 includes a number of advertiser networks 102a-102n (two illustrated, collectively 102), a number of advertisers 104a-104n (two illustrated, collectively 104), a number of content providers 106a, 106b-106n (three illustrated, collectively 106), and a number of end users 108a-108n (two illustrated, collectively 108), all communicatively coupled by one or more networks or other communications channels 110.

The advertiser networks 102 serve as an exchange or clearing house to display advertisement placement opportunities and related information, to allow reserving, committing to, purchasing of or placement of advertisements including, for instance, bidding or offers on advertisement placement opportunities, and automating placement of advertisements as insertions into a flow or stream of content provided by the content providers 106. Such allows content providers 106 to display the availability of advertisement placement opportunities to place advertisements. Such also allows advertisers 104 to view advertisement placement opportunities, reserve, bid or make an offer on advertisement placement opportunities, or otherwise place advertisements in the advertisement placement opportunities. Such may also automatically insert advertisements in a flow or stream of content provided by the content providers 106. For example, placed advertisements may be inserted in streamed content as a substitute for, or in place of, advertisements or other material that was part of an original broadcast of content by the content provider 106.

The advertiser networks 102 each include one or more advertiser network server computer systems 112a, 112n (collectively 112, only one shown for each advertiser network 102) communicatively coupled to communicate via the one or more networks or other communications channels 110. The advertiser networks 102 each include one or more nontransitory computer- or processor-readable storage media which stores an advertisement content inventory 114a, 114n (collectively 114, only one shown for each advertiser network 102). The advertiser networks 102 each include one or more nontransitory computer- or processor-readable storage media which stores an inventory of advertisement placement opportunities 116a, 116n (collectively 116, only one shown for each advertiser network 102) to place advertisements in broadcasts and/or Webcasts for each of a plurality of broadcast and/or Webcast content providers that transmit broadcasts and/or Webcasts. The advertiser network server computer systems 112 are communicatively coupled to the storage media which stores an advertisement content inventory 114 and/or to the storage media which stores an inventory of advertisement placement opportunities 116 and executes instructions that cause the advertiser network server computer systems 112 to store, retrieve and/or update the information in the advertisement content inventory 114 and/or advertisement placement opportunities inventory 116.

The advertisers 104 are generally the source of advertising content, or other content, to be inserted in a stream or flow of media (e.g., radio broadcast, television broadcast, Webcast). The advertisers 104 may be the subject of the advertising content, for instance, a company or other entity which the advertisement is about or advertises. Alternatively, the advertisers 104 may be an originator or creator of the advertisement or otherwise entrusted with placing advertising by the subject of the advertisement (e.g., advertising agency).

The advertisers 104 each include one or more advertiser computer systems 118a-118n (collectively 118, only two shown). The advertiser computer systems 118 may take any of a large variety of forms, including personal or microcomputers, including laptop and desktop computers, minicomputers, workstations, server computers, and even mainframe computers. The advertiser computer systems 118 are communicatively coupled to provide advertisement content (i.e., advertisement) and related information to at least one of the advertisement network server computer systems 112 of one or more of the advertiser networks 102. The related information may specify advertisement placement criteria, for example, length of advertisement, type of media or format, language, general population target demographics, specific individual target demographics.

The content providers 106 may take a variety of forms, for example, radio stations or broadcasters 106a, television stations or broadcasters 106b, other terrestrial or satellite broadcasters or multicasters (not shown), Webcasters 106c, etc. The content providers 106 may, or may not, own the content that they provide. Many content providers 106 earn revenue by selling blocks of advertising time or impressions. Content providers 106 may, or may not, provide free public service announcements. Many content providers 106 would commercially benefit from a robust market for blocks of advertising time or impressions.

A radio broadcaster 106a may include one or more content provider computer systems 120a communicatively coupled to provide advertisement placement opportunities to one or more of the advertising networks 102. The content provider computer system 120a may take any of a large variety of forms, including personal or microcomputers, including laptop and desktop computers, minicomputers, workstations, server computers, and even mainframe computers.

Radio broadcaster 106a will typically include a source of content, for example, a sound board 122a or similar device. The radio broadcaster 106a will typically include one or more transmitters 124a and antennas 126a to wirelessly transmit programming. Various types of transmitters 124a and antennas 126a may be suitable, for example, commercially available transmitters and antennas for amplitude modulated (AM) or frequency modulated (FM) or other forms of wireless communications. Typically, additional circuitry is present to filter and otherwise condition or process the signals. Radio broadcasters 106a often employ transponders or repeaters (neither shown) to extend the range or coverage of their service area.

Typically, the radio broadcaster 106a will have, or will employ another party's content provider content server computer system 128a which serves or Webcasts programming. Such allows distribution of programming outside the radio broadcaster's 106a service area or range.

The radio broadcaster 106a includes a material or advertisement insertion system (AIS) 130a. The AIS 130a is coupled to receive programming from the sound board 122a. The AIS 130a is also communicatively coupled to receive audio material to be inserted in the programming, for example, placed advertisements. The material may, for example, be inserted in defined segments or blocks of the programming material, for example, in advertisement segments or blocks, for instance, in place of or as a substitute for advertisements in the broadcast programming. Such may, for example, allow replacement of material that is of local interest with material that is more appropriate for a wider audience or even more appropriate for a more specific audience. As explained in more detail herein, the AIS 130a may use caching to allow the replacement material to, in some instances, fit within a segment or block, or in other instances, overlap or partially overlap the segment or block. The AIS 130a provides the programming, with the inserted material, to the content provider content server 128a for transmission over a network infrastructure, such as the Worldwide Web portion of the Internet. The AIS 130a may attempt to maintain the streaming of modified programming approximately concurrent with the radio broadcast.

A television broadcaster 106b may include one or more content provider computer systems 120b communicatively coupled to provide advertisement placement opportunities to one or more of the advertising networks 102. The content provider computer systems 120b may take any of a large variety of forms, including personal or microcomputers including laptop and desktop computers, minicomputers, workstations server computers, and even mainframe computers.

Television broadcaster 106b will typically include a source of content, which may be supplied via a video board 122b or similar device. The television broadcaster 106b will typically include one or more transmitters 124b and antennas 126b to wirelessly transmit programming. Various types of transmitters 124b and antennas 126b may be suitable, for example, commercially available transmitters 124b and antennas 126b for analog (e.g., NTSC standard) or digital (e.g., ATSC standard) broadcasts. Typically, additional circuitry is present to filter and otherwise condition or process the signals. Television broadcasters 106b often employ transponders or repeaters (neither shown) to extend the range or coverage of their service area.

Typically, the television broadcaster 106b will have, or will employ another party's, content provider content server 128b which serves or Webcasts programming. Such allows distribution of programming outside the television broadcaster's 106b service area or range.

Similar to the radio broadcaster 106a, the television broadcaster 106b may include an AIS 130b. The AIS 130b is coupled to receive programming from the video board 122b. The AIS 130b is also communicatively coupled to receive video material to be inserted in the programming, for example, placed advertisements. The material may, for example, be inserted in defined segments or blocks of the programming material, for example, in advertisement segments or blocks, for instance, in place of or as a substitute for advertisements in the broadcast programming. Such may, for example, allow replacement of material that is of local interest with material that is more appropriate for a wider audience or even that is more appropriate for a more specific audience. As explained in more detail herein, the AIS 130b may use caching to allow the replacement material to in some instances fit within a segment or block, or in other instances overlap or partially overlap the segment or block. The AIS 130b provides the programming, with the inserted material, to the content provider content server 128b for transmission over a network infrastructure, such as the Worldwide Web portion of the Internet. The AIS 130b may attempt to maintain the streaming of modified programming approximately concurrent with the television broadcast.

A Webcaster 106n may include one or more content provider computer systems 120n communicatively coupled to provide advertisement placement opportunities to one or more of the advertising networks 102. The content provider computer systems 120n may take any of a large variety of forms, including personal or microcomputers, including laptop and desktop computers, minicomputers, workstations, server computers, and even mainframe computers.

Webcaster 106b will typically include a source of content, which may be supplied via a nontransitory computer- or processor-readable medium that stores one or more WebPages or other content 122n or similar device. Typically, the Webcaster 106b will have, or will employ another party's, content provider content server 128b which serves or Webcasts programming.

Similar to the radio broadcaster 106a and television broadcaster 106b, the Webcaster 106n may include an AIS 130n. The AIS 130n is coupled to receive content from the store one or more WebPages or other content 122n. The AIS 130b is also communicatively coupled to receive material to be inserted in the content, for example, placed advertisements (e.g., preroll advertisement which appear before a video or FLASH® player clip, banner advertisements). The material may, for example, be inserted in defined segments or blocks of the content, for example, in defined portions of WebPages, for instance, in place of or as a substitute for other advertisements in the content or simply before, during or following some segment of content (e.g., preroll advertisement which appear before a video or FLASH® player clip). Such may, for example, allow replacement of material that is of more appropriate for a more specific audience. As explained in more detail herein, the AIS 130b may use caching to allow the replacement material to in some instances fit within a segment or block, or in other instances overlap or partially overlap the segment or block. The AIS 130b provides the programming, with the inserted material, to the content provider content server 128b for transmission over a network infrastructure, such as the Worldwide Web portion of the Internet.

End users 108 may employ any of a large variety of devices. For example, end users 108 may employ personal computers 132a such as desktop computers, laptop computers, netbooks or tablet computers. Also, for example, end users 108 may employ mobile devices 132b, such as smart phones, personal digital assistants.

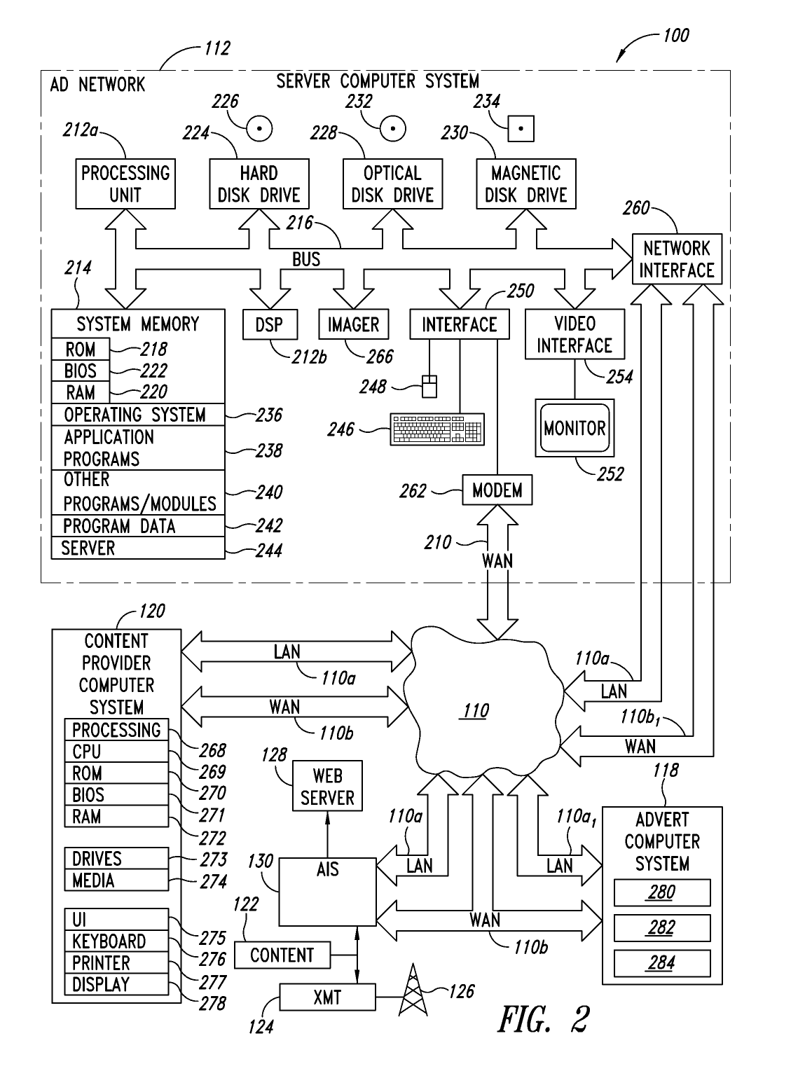

FIG. 2 shows a portion of the environment 100 comprising advertising network server computer system 112, an advertiser computer system 118, a content provider computer system 120, store or inventory of content 122, content provider content server computer system 128, AIS 130, and optional transmitter 124 and antenna 126, communicatively coupled by one or more communications channels, for example, one or more networks 110, for example, one or more local area networks (LANs) 110a and/or wide area networks (WANs) 110b.

The advertising network server computer system 112 will at times be referred to in the singular herein, but this is not intended to limit the embodiments to a single device or system since in typical embodiments, there may be more than one advertising network server computer system 112 involved. Unless described otherwise, the construction and operation of the various blocks shown in FIG. 2 are of conventional design. As a result, such blocks need not be described in further detail herein, as they will be understood by those skilled in the relevant art.

The advertising network server computer system 112 may include one or more processing units 212a, 212b (collectively 212), a system memory 214 and a system bus 216 that couples various system components including the system memory 214 to the processing units 212. The processing units 212 may be any logic processing unit, such as one or more central processing units (CPUs) 212a, digital signal processors (DSPs) 212b, application-specific integrated circuits (ASICs), field programmable gate arrays (FPGAs), etc. The system bus 216 can employ any known bus structures or architectures, including a memory bus with memory controller, a peripheral bus, and a local bus. The system memory 214 includes read-only memory (“ROM”) 218 and random access memory (“RAM”) 220. A basic input/output system (“BIOS”) 222, which can form part of the ROM 218, contains basic routines that help transfer information between elements within the advertising network server computer system 112, such as during start-up.

The advertising network server computer system 112 may include a hard disk drive 224 for reading from and writing to a hard disk 226, an optical disk drive 228 for reading from and writing to removable optical disks 232, and/or a magnetic disk drive 230 for reading from and writing to magnetic disks 234. The optical disk 232 can be a CD/DVD-ROM, while the magnetic disk 234 can be a magnetic floppy disk or diskette. The hard disk drive 224, optical disk drive 228 and magnetic disk drive 230 may communicate with the processing unit 212 via the system bus 216. The hard disk drive 224, optical disk drive 228 and magnetic disk drive 230 may include interfaces or controllers (not shown) coupled between such drives and the system bus 216, as is known by those skilled in the relevant art. The drives 224, 228 and 230, and their associated computer-readable storage media 226, 232, 234, may provide nonvolatile and non-transitory storage of computer readable instructions, data structures, program engines and other data for the advertising network server computer system 112. Although the depicted advertising network server computer system 112 is illustrated employing a hard disk 224, optical disk 228 and magnetic disk 230, those skilled in the relevant art will appreciate that other types of computer-readable storage media that can store data accessible by a computer may be employed, such as magnetic cassettes, flash memory, digital video disks (“DVD”), Bernoulli cartridges, RAMs, ROMs, smart cards, etc. The hard disk 226 may, for example, store advertising content inventory and related information and/or advertising placement opportunity inventory and related information.

Program engines can be stored in the system memory 214, such as an operating system 236, one or more application programs 238, other programs or engines 240 and program data 242. Application programs 238 may include instructions that cause the processor(s) 212 to automatically store, update, present, offer advertisement placement opportunities and related information to potential advertisers or their representatives. Application programs 238 may include instructions that cause the processor(s) 212 to automatically store and update material intended for insertion into flows or streams of information, for example, advertisements or advertising content and related information.

Other program engines 240 may include instructions for handling security such as password or other access protection and communications encryption. The system memory 214 may also include communications programs, for example, a server 244 for permitting the advertising network server computer system 112 to provide services and exchange data with other computer systems or devices via the Internet, corporate intranets, extranets, or other networks as described below, as well as other server applications on server computing systems such as those discussed further herein. The server 244 in the depicted embodiment may be markup language based, such as Hypertext Markup Language (HTML), Extensible Markup Language (XML) or Wireless Markup Language (WML), and operates with markup languages that use syntactically delimited characters added to the data of a document to represent the structure of the document. A number of servers are commercially available such as those from Microsoft, Oracle, IBM and Apple.

While shown in FIG. 2 as being stored in the system memory 214, the operating system 236, application programs 238, other programs/engines 240, program data 242 and server 244 can be stored on the hard disk 226 of the hard disk drive 224, the optical disk 232 of the optical disk drive 228 and/or the magnetic disk 234 of the magnetic disk drive 230.

An operator can enter commands and information into the advertising network server computer system 112 through input devices such as a touch screen or keyboard 246 and/or a pointing device such as a mouse 248, and/or via a graphical user interface. Other input devices can include a microphone, joystick, game pad, tablet, scanner, etc. These and other input devices are connected to one or more of the processing units 212 through an interface 250 such as a serial port interface that couples to the system bus 216, although other interfaces such as a parallel port, a game port or a wireless interface or a universal serial bus (“USB”) can be used. A monitor 252 or other display device is coupled to the system bus 216 via a video interface 254, such as a video adapter. The advertising network server computer system 112 can include other output devices, such as speakers, printers, etc.

The advertising network server computer system 112 can operate in a networked environment using logical connections to one or more remote computers and/or devices as described above with reference to FIG. 1. For example, the advertising network server computer system 112 can operate in a networked environment using logical connections to one or more advertiser computer systems 118, content provider computer systems 120, content provider content server computer systems 128 and/or AIS 130. Communications may be via a wired and/or wireless network architecture, for instance, wired and wireless enterprise-wide computer networks, intranets, extranets, and the Internet. Other embodiments may include other types of communication networks including telecommunications networks, cellular networks, paging networks, and other mobile networks.

The content provider computer system 120 may take the form of a conventional mainframe computer, mini-computer, workstation computer, personal computer (desktop or laptop), or handheld computer. The content provider computer system 120 may include a processing unit 268, a system memory 269 and a system bus (not shown) that couples various system components including the system memory 269 to the processing unit 268. The content provider computer system 120 will at times be referred to in the singular herein, but this is not intended to limit the embodiments to a single sending client computer system 114a since in typical embodiments, there may be more than one content provider computer system 120 or other device involved. Non-limiting examples of commercially available computer systems include, but are not limited to, an 80×86, Pentium, or i7 series microprocessor from Intel Corporation, U.S.A., a PowerPC microprocessor from IBM, a Sparc microprocessor from Sun Microsystems, Inc., a PA-RISC series microprocessor from Hewlett-Packard Company, or a 68xxx series microprocessor from Motorola Corporation.

The processing unit 268 may be any logic processing unit, such as one or more central processing units (CPUs), digital signal processors (DSPs), application-specific integrated circuits (ASICs), field programmable gate arrays (FPGAs), etc. Unless described otherwise, the construction and operation of the various blocks of the content provider computer system 120 shown in FIG. 2 are of conventional design. As a result, such blocks need not be described in further detail herein, as they will be understood by those skilled in the relevant art.

The system bus can employ any known bus structures or architectures, including a memory bus with memory controller, a peripheral bus, and a local bus. The system memory 269 includes read-only memory (“ROM”) 270 and random access memory (“RAM”) 272. A basic input/output system (“BIOS”) 271, which can form part of the ROM 270, contains basic routines that help transfer information between elements within the sending client computer system 114a, such as during start-up.

The content provider computer system 120 may also include one or more media drives 273 (e.g., a hard disk drive, magnetic disk drive, and/or optical disk drive) for reading from and writing to computer-readable storage media 274 (e.g., hard disk, optical disks, and/or magnetic disks). The computer-readable storage media 274 may, for example, take the form of removable media. For example, hard disks may take the form of a Winchester drives, optical disks can take the form of CD-ROMs, while magnetic disks can take the form of magnetic floppy disks or diskettes. The media drive(s) 273 communicate with the processing unit 268 via one or more system buses. The media drives 273 may include interfaces or controllers (not shown) coupled between such drives and the system bus, as is known by those skilled in the relevant art. The media drives 273, and their associated computer-readable storage media 274, provide nonvolatile storage of computer readable instructions, data structures, program engines and other data for the content provider computer system 120. Although described as employing computer-readable storage media 274 such as hard disks, optical disks and magnetic disks, those skilled in the relevant art will appreciate that content provider computer system 120 may employ other types of computer-readable storage media that can store data accessible by a computer, such as magnetic cassettes, flash memory cards, digital video disks (“DVD”), Bernoulli cartridges, RAMs, ROMs, smart cards, etc. Data or information, for example, data from human resource management programs or tools, third party tracking programs or tools, etc., can be stored in the computer-readable storage media 274.

Program engines, such as an operating system, one or more application programs, other programs or engines and program data, can be stored in the system memory 269. Program engines may include instructions to identify, catalog and otherwise specify advertisement placement opportunities to place advertising in programming that is provided, carried, broadcast or otherwise transmitted by the content provider. Program engines may include instructions for handling security such as password or other access protection and communications encryption. The system memory 269 may also include communications programs, for example, a Web client or browser that permits the content provider computer system 120 to access and exchange data with sources such as Web sites of the Internet, corporate intranets, extranets, or other networks as described below, as well as other server applications on server computing systems such as those discussed further below. The browser may, for example, be markup language based, such as Hypertext Markup Language (HTML), Extensible Markup Language (XML) or Wireless Markup Language (WML), and may operate with markup languages that use syntactically delimited characters added to the data of a document to represent the structure of the document.

While described as being stored in the system memory 269, the operating system, application programs, other programs/engines, program data and/or browser can be stored on the computer-readable storage media 274 of the media drive(s) 273. An operator can enter commands and information into the sending client computer system 114a via a user interface 275 through input devices such as a touch screen or keyboard 276 and/or a pointing device 277 such as a mouse. Other input devices can include a microphone, joystick, game pad, tablet, scanner, etc. These and other input devices are connected to the processing unit 269 through an interface such as a serial port interface that couples to the system bus, although other interfaces such as a parallel port, a game port or a wireless interface or a universal serial bus (“USB”) can be used. A display or monitor 278 may be coupled to the system bus via a video interface, such as a video adapter. The content provider computer system 120 can include other output devices, such as speakers, printers, etc.

The content provider computer system 120 includes instructions stored in non-transitory computer-readable storage media that cause the processor(s) of the content provider computer system 120 to provide information specifying the availability of various advertisement placement opportunities to the advertising network server computer system 112, along with supporting information such as media type (e.g., radio, television, Web video) information or format (e.g., adult contemporary, pop, classic rock, classical, jazz, talk, sports) information, language of broadcast (e.g., English, Spanish), day, time, duration of advertisement placement opportunities, information specifying particular content or programming temporally or spatially proximate the advertisement placement opportunities, general demographic information regarding the content provider's audience, specific demographic information about specific members of the content provider's audience. The instructions also allow the advertisement placement opportunities to receive information regarding reservation, purchase, acceptance of advertisement placement opportunities or placement of advertisements.

The advertiser computer system 118 may have identical or similar components to the previously described computer systems. The advertiser computer system 118 may include a processing subsystem 280 including one or more non-transitory processor and computer-readable memories, a media subsystem 282 including one or more drives and computer-readable storage media, and one or more user interface subsystems 284 including one or more keyboards, keypads, displays, pointing devices, graphical interfaces and/or printers.

The advertiser computer system 118 includes instructions stored in non-transitory computer-readable storage media that cause the processor(s) of the advertiser computer system 118 to request and/or review an inventory of advertisement placement opportunities that are currently available. The instructions may also cause the processor(s) of the advertiser computer system 118 to advertiser computer system 118 may then transmit or otherwise provide advertisements or advertising content and related information to the advertisement network server computer system 112, or even directly to the AIS 130.

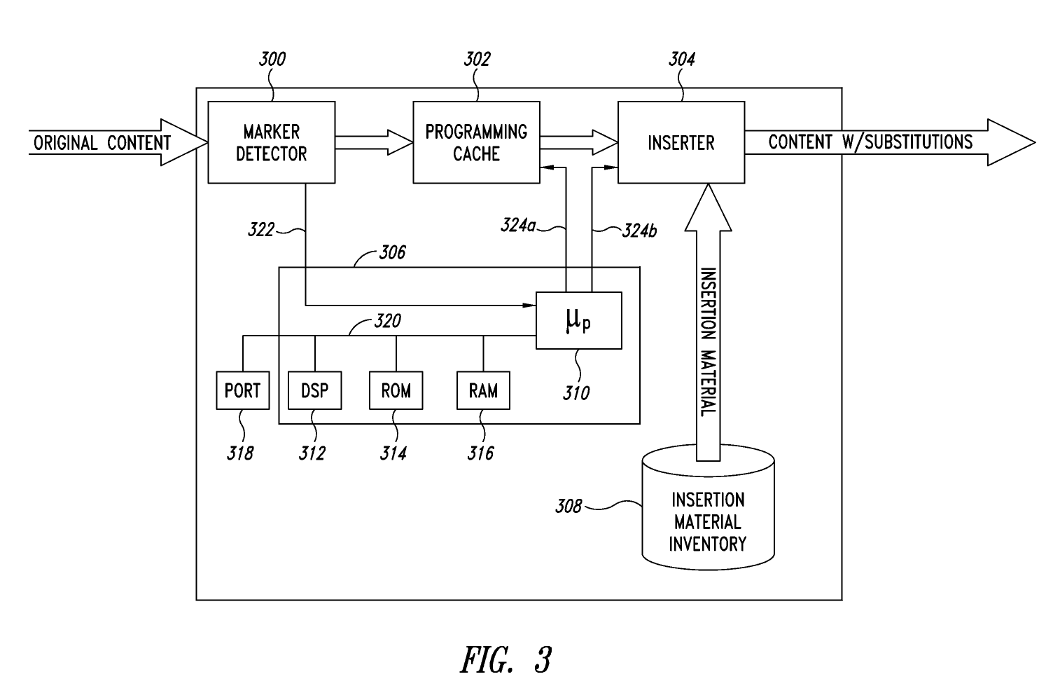

FIG. 3 shows an AIS component 130, according to one illustrated embodiment.

The AIS component 130 includes a marker detector 300, a programming cache 302, an inserter 304, a control subsystem 306, and a nontransitory computer- or processor-readable medium that stores material to be inserted into programming (i.e., insertion material inventory 308). The AIS component 130 is communicatively coupled to receive original programming from a content provider system, for instance, a sound board 122a (FIG. 1), video board 122b (FIG. 1), collection of content such as WebPages 122n (FIG. 1) any other source of content.

The marker detector 300 detects transitions in programming. The marker detector 300 may, for example, detect the start and/or end of advertisement blocks or segments in the programming. The marker detector 300 may, for example, detect the start and/or end of content, for instance, non-advertising content in the programming. Many types of programming includes indicators or markers that mark the start and/or end of certain segments, for instance, marking the start or end of a block of advertisements and/or the start or end of the non-advertisement content. In some instances, the indicators or markers are simply mark the occurrence of the start or end of a segment. In other instances, these indicators or markers include information about the respective segment. For example, a start indicator or marker may include information that specifies a duration of the segment. The indicators or markers may additionally, or alternatively include other information. The marker detector 300 scans the programming signal for these indicators or markers and produces signals in response to detection of the same. The marker detector 300 may also extract any information included in, or with, the indicator marker, for instance, an indication of a duration of the segment.

The cache 302 is downstream from the marker detector 300 and caches the programming. Such allows time shifting of programming material, which may increase flexibility of the AIS component 130. For example, where a duration of replacement material matches a duration of material being replaced, the amount of material cached by the cache 302 may remain constant or not change. Where a duration of replacement material exceeds a duration of material being replaced, the amount of material cached by the cache 302 may grow or increase. Where a duration of replacement material is less than a duration of material being replaced, the amount of material cached may shrink or be reduced. Such may advantageously allow selection of material for insertion having durations that do not exactly match the durations of the segments in which the material will be inserted. For example, a number of advertisements to be inserted into an advertising block or segment may have a combined duration that is greater or less than a duration of the advertising block or segment.

The AIS component 130 may be configured or programmed to reduce, over time, differences in timing between a broadcast of the programming and a streaming of the programming with the insertion. Thus, in some instances a segment of a broadcast of particular programming may appear slightly earlier in time than an appearance of the same segment in a streaming of the programming. Over time, that difference may be reduced, or even reverse with a subsequent segment in the streaming appearing slightly before the same subsequently segment appears in the broadcast of the programming. Such may be accomplished using the cache 302 and via selection of insertion material that trends over time to reduce the differences in timing between the broadcast and the streaming. Thus, where the broadcast is ahead of the streaming, selection of replacement material of a shorter duration than material to be replaced will tend to reduce the difference. Where the broadcast is behind the streaming, selection of replacement material of a longer duration than material to be replaced will tend to reduce the difference. Various nontransitory processor- or computer-readable media may be employed as the cache 302.

The inserter 304 is coupled downstream of the cache 302. The inserter 304 selectively inserts material to be inserted into the programming. For example, the inserter 304 may insert material from the insertion material inventory 308 into particular segments of the programming. The material being inserted may, for example, replace other material. For instance, advertisements (e.g., commercial advertisements or commercials) appearing in programming that is broadcast by the content provider may be replaced with other advertisements. In some instances, the material to be inserted may be more appropriate for an audience or target audience that receives programming via the Worldwide Web as compared to an audience or target audience that receives programming via radio or television broadcasts. The inserter 304 can take a variety of forms, as simply as a switch that selectively couples the material to be inserted from the insertion material inventory 308 to a downstream component or output of the AIS component 130.

The AIS component 130 may be similar or identical in structure and/or operation to the content injection system described in U.S. patent application publication No. 2008/0120638 published May 22, 2008. That content injection system advantageously employs caching so that replacement material does not need to be exactly the same length or duration as the material being replaced. Additionally, or alternatively, the AIS may in some respects be similar or identical in structure and/or operation to that described in U.S. patent application publication No. 2007/0074243. Additionally, or alternatively, the AIS may in some respects be similar or identical in structure and/or operation to that described in U.S. Pat. No. 6,577,716.

The control subsystem 306 may take a variety of forms. Typically, the control subsystem 306 will include one or more controllers, for example, microprocessors 310, DSPs 312, ASICs, PGAs, microcontrollers or the like. The control subsystem 306 will also typically include one or more nontransitory nonvolatile memories such as ROM or FLASH memory 314 and/or one or more volatile memories such as RAM 316. The control subsystem 306 may also include one or more communications ports 318, for example, parallel communications ports (e.g., Ethernet port) or serial communications ports (e.g., Universal Serial Bus ports). The communications ports 318 may allow wired and/or wireless communications with the AIS component 130. The various components of the control subsystem 306 may be coupled via one or more buses 320 (only one shown), for example, one or more power buses, communications buses, instruction buses, address buses, data buses, etc.

The control subsystem 306 is configured or programmed to control the operation of the AIS component 130. The control subsystem 306 is communicatively coupled to receive signals from the marker detector 300 via line 322. The signals may be indicative of the start, end and/or duration of a segment in the programming. The signals may also be indicative of other information, for instance, the type of segment, content of the segment, format of the segment or language of the segment. The control subsystem 306 uses the information received from the marker detector to determine when to insert material. For example, the control subsystem 306 may determine to insert advertising material at the start of an advertising segment or block of the programming. The insertion material may, for example, be replacement material, for instance, to replace less appropriate or less targeted material with more appropriate or more targeted material.

The control subsystem 306 may determine a length or duration of the advertising segment or block of the programming and selected insertion material based on the determined length or duration of advertising segment or block of the programming. As described above, the control subsystem 306 may not attempt to exactly match the length or duration of advertising segment or block of the programming, but rather may select insertion material of somewhat longer or shorter durations.

The control subsystem 306 may base the selection on a variety of factors or parameters. For example, the control subsystem 306 may base the selection at least in part on a total amount of revenue generated by the inserted material, for instance, placed advertisements. For instance, the control subsystem 306 may attempt to maximize the revenue generated by placements of advertising. Also for example, the control subsystem 306 may base the selection at least in part on an appropriateness of the material to be inserted. For instance, the control subsystem 306 may select the insertion material in part on an attempt to match a format, language, general demographic or specific demographic of the insertion material with that of an audience or target audience of the programming which will be streamed or otherwise delivered separately from the broadcast. This advantageously allows differences between audiences of broadcasts and Web based viewing or listening to be accommodated. As a further example, the control subsystem 306 may select the insertion material at least in part to match, to some degree, the duration or length of material to be inserted with the duration or length of the segment. As previously explained caching allows inexact matching of duration or length. The control subsystem 306 may at least in part base selection the insertion material to reduce a lead or lag of the streamed programming with respect to the broadcasted programming. Thus, the control subsystem 306 may select material for insertion that is longer than the segment provided for insertion where the streamed programming lags the broadcasted programming. Alternatively, the control subsystem 306 may select material for insertion that is shorter than the segment provided for insertion where the streamed programming leads the broadcasted programming.

The control subsystem 306 provides control signals via control lines 324a, 324b to the cache 302 and inserter 304 to control the caching and insertion of material into the programming. The control signals may cause the cache to retain or collect programming while the inserter is still inserting material.

The control subsystem 306 may be responsive at least in part to one or more advertiser network server computer systems 112 (FIG. 1). For example, the material for the insertion material inventory 308 may be provided via the advertiser network server computer systems 112. Additionally, or alternatively, the advertiser network server computer systems 112 may indicate which advertisements to insert into which advertisement placement opportunities. Such may be performed, for example, based on demographic information regarding the audience, demographic information regarding the target audience for the advertisement, and/or maximize advertising revenue generated by the advertisement insertions.

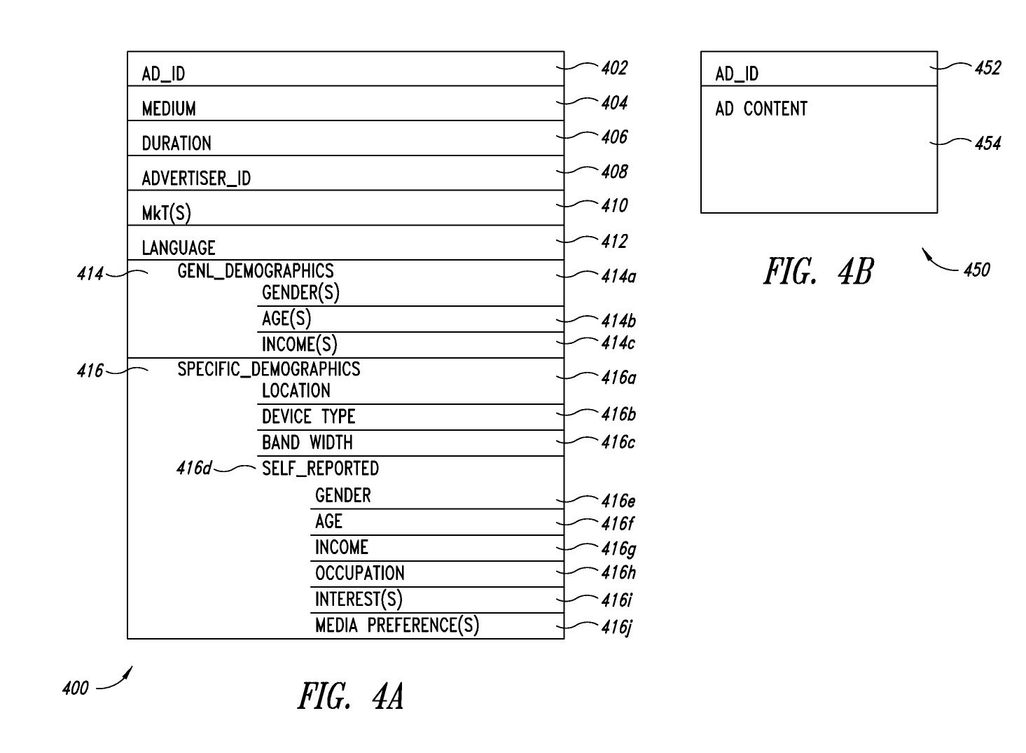

FIG. 4A shows a data structure 400 to store advertisement related information, according to one illustrated embodiment in the form of a record with a variety of fields.

The data structure 400 may store an advertisement identifier 402 that uniquely identifies an advertisement.

The data structure 400 may store a medium identifier 404 that identifies a type of medium in which the advertisement may run. The medium identifier 404 may, for example, specify one or more of radio, television, Web, etc. mediums.

The data structure 400 may store a duration indication 406 that specifies a duration of the associated advertisement.

The data structure 400 may store an advertiser identifier 408 that uniquely identifies an advertiser to which the advertisement related or is owned.

The data structure 400 may store a markets identifier 410 that identifies one or more geographic markets (e.g., NYC, Pacific Northwest, Seattle) or other markets (e.g., high technology, industrial supply) to which the advertisement is targeted.

The data structure 400 may store a language identifier 412 that identifies a language (e.g., English, Spanish) of the advertisement.

The data structure 400 may store general population demographic information 414 that specifies the demographics of the audience(s) to which the advertisement is targeted. The general population demographic information 414 may include a large variety of information, for example, gender(s) 414a (e.g., male, female, both), age(s) 414b (e.g., 21-30 year olds), incomes 414c (e.g., over $50,000 per year). Other or different generalized population demographic information may be employed.

The data structure 400 may store specific demographic information 416 that specifies the demographics of specific audience(s) or individual members of an audience to which the advertisement is targeted. Such may be useful where information for particular individuals in an audience have been collected, for instance, automatically collected or collected via self-reporting by those individuals. The specific demographic information 416 may include a large variety of information.

The specific demographic information 416 may, for example, indicate a current location 416a of an individual. The current location 416a may be a fairly specific geographic location, which may be discernable, for example, from an Internet address, telephone area code and prefix, or from cellular location information. The current location 416a may represent a type of location, for example, fixed or mobile, which may, for instance, be discerned from an Internet address or device type (e.g., Smartphone operating on cellular system versus operating on WI-FI, satellite radio, DSL line).

The specific demographic information 416 may, for example, indicate a device type 416b employed by an individual. For instance, the device type 416b may indicate a general device type (e.g., computer, tablet, Smartphone), or a more specific device type (e.g., manufacturer and model). Such may be determined, for example, by querying the device.

The specific demographic information 416 may, for example, indicate a bandwidth or service level 416c available to an individual. Available bandwidth or service level 416c may be discernable from the type of communications infrastructure involved, (e.g., cellular, WI-FI, DSL, cable modem) and/or device type.

The specific demographic information 416 may, for example, include self reported demographic information 416d. Such may include information that is not readily discernable without self reporting. The self reported specific demographic information 416 may, for example, indicate a gender 416e of an individual. The self reported specific demographic information 416 may, for example, indicate an actual age 416f of the individual (e.g., 47 year old). The self reported specific demographic information 416 may, for example, indicate an income 416g of an individual (e.g., $50,000 per year). The self reported specific demographic information 416 may, for example, indicate an occupation 416h of the individual (e.g., engineer, salesperson). The self reported specific demographic information 416 may, for example, indicate interests 416i of an individual (e.g., pilot, snorkeling, leisure reading). The self reported specific demographic information 416 may, for example, indicate media preferences 416j of an individual (e.g., certain periodicals, television or radio shows or stations).

FIG. 4B shows a data structure 450 to store advertisements, according to one illustrated embodiment in the form of a record with a variety of fields.

The data structure 450 may store an advertisement identifier 452 that uniquely identifies an advertisement.

The data structure 450 may store advertisement content 454. The advertisement content may take many variety of forms, for example, audio files, video files, WebPages, banners, popup, or pop files. The advertisement content may be formed in any of a large variety of formats, for example, AVI, DivX, MPEG, SVCD, VCD, WMV, XVCD, XSVCD, MP3 files, MP4 files, HTML files, XML, Flash®, AAC, mov, H.264, MKV files, etc.

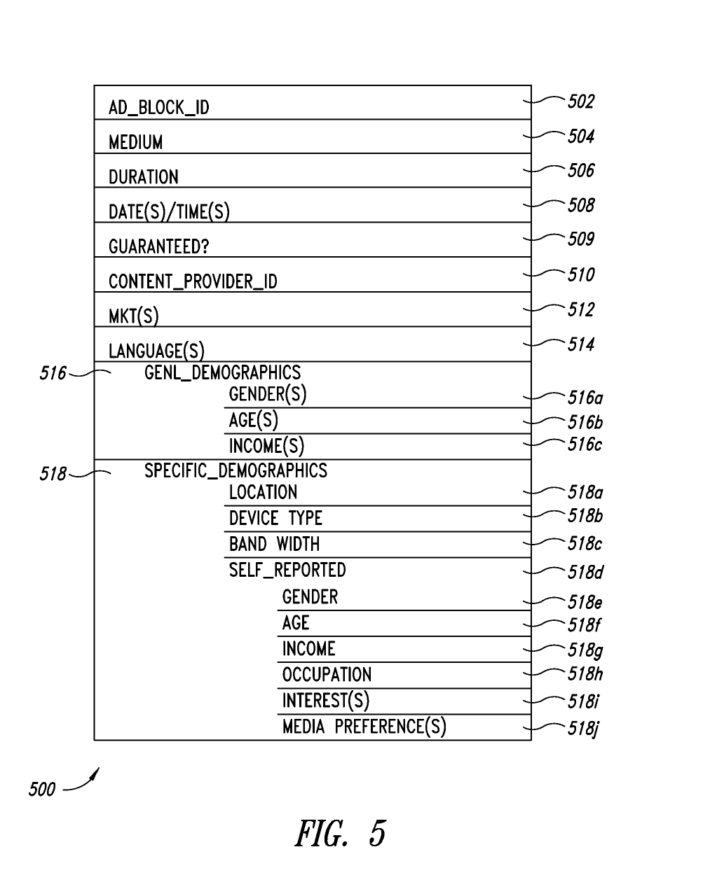

FIG. 5 shows a data structure 500 to store advertisement placement opportunity related information, according to one illustrated embodiment in the form of a record with a variety of fields.

The data structure 500 may store an advertisement placement opportunity identifier 502 that uniquely identifies an advertisement placement opportunity. Such may correspond to an available segment or sub segment of programming.

The data structure 500 may store a medium identifier 504 that identifies a type of medium in which the advertisement may run. The medium identifier 504 may, for example, specify one or more of radio, television, Web, etc. mediums.

The data structure 500 may store a duration indication 506 that specifies a duration (e.g., 15 seconds, 30 seconds, 60 seconds) of the available advertisement placement opportunity.

The data structure 500 may store a date and/or time identifier 508 that uniquely identifies a date and/or time of the available advertisement placement opportunity. Such may specify date by day of year, by day of week, or season.

Time may be specified in any desired time zone, for example, a time zone in which the programming will be broadcast.

The data structure 500 may store a guaranteed indication 509 that specifies whether a content provider ensures that an advertisement if placed for the respective available advertisement placement opportunity is guaranteed to be broadcast, assuming the advertisement meets any guidelines or conditions applied by the respective content provider to advertising in its programming.

The data structure 500 may store a content provider identifier 510 that specifies a content provider identifier that uniquely identifies a content provider (e.g., KUOW, WNEW, ABC, WABC, TBS) which will be broadcasting or otherwise transmitting the programming.

The data structure 500 may store a markets identifier 512 that identifies one or more geographic markets (e.g., NYC, Pacific Northwest) or other markets (e.g., high technology, industrial supply) to which the advertisement is targeted.

The data structure 500 may store a language identifier 514 that identifies a language (e.g., English, Spanish) of the programming associated with the available advertisement placement opportunity. It is likely that an advertiser will employ the same language for an advertisement as the language of the main programming since the audience may be expected to understand that language.

The data structure 500 may store general population demographic information 516 that specifies the demographics of the generally audience(s) to which the programming and/or the content provider's broadcasting or Webcasting is targeted. The general population demographic information 516 may include a large variety of information, for example, gender(s) 516a (e.g., male, female, both), age(s) 516b (e.g., 21-30 year olds), incomes 516c (e.g., over $50,000 per year). Other or different generalized population demographic information may be employed.

The data structure 500 may store specific demographic information 518 that specifies the demographics of specific audience(s) or individual members of an audience to which the programming or the content provider's broadcasting or Webcasting is targeted. Such may be useful where information for particular individuals in an audience have been collected, for instance, automatically collected or collected via self-reporting by those individuals. The specific demographic information 518 may include a large variety of information.

The specific demographic information 518 may, for example, indicate a current location 518a of an individual. The current location 518a may be a fairly specific geographic location, which may be discernable, for example, from an Internet address, telephone area code and prefix, or from cellular location information. The current location 518a may represent a type of location, for example, fixed or mobile, which may, for instance, be discerned from an Internet address or device type (e.g., Smartphone operating on cellular system versus operating on WI-FI, satellite radio, DSL line).

The specific demographic information 518 may, for example, indicate a device type 518b employed by an individual. For instance, the device type 518b may indicate a general device type (e.g., computer, tablet, Smartphone), or a more specific device type (e.g., manufacturer and model). Such may be determined, for example, by querying the device.

The specific demographic information 518 may, for example, indicate a bandwidth or service level 518c available to an individual. Available bandwidth or service level 518c may be discernable from the type of communications infrastructure involved, (e.g., cellular, WI-FI, DSL, cable modem) and/or device type.

The specific demographic information 518 may, for example, include self reported demographic information 518d. Such may include information that is not readily discernable without self reporting. The self reported specific demographic information 518 may, for example, indicate a gender 518e of an individual. The self reported specific demographic information 518 may, for example, indicate an actual age 518f of the individual (e.g., 47 year old). The self reported specific demographic information 518 may, for example, indicate an income 518g of an individual (e.g., $50,000 per year). The self reported specific demographic information 518 may, for example, indicate an occupation 518h of the individual (e.g., engineer, salesperson). The self reported specific demographic information 518 may, for example, indicate interests 518i of an individual (e.g., pilot, snorkeling, leisure reading). The self reported specific demographic information 518 may, for example, indicate media preferences 518j of an individual (e.g., certain periodicals, television or radio shows or stations).

The above examples of data structures, and examples of specific types of information are intended to be illustrative and not limiting. In some instances, additional information may be employed and some of the illustrated information omitted. Also, different data structures may be employed and/or the information may be stored in different data structures or different ways. For example, a separate content provider specific data structure may be employed to store information related to respective content providers. Also for example, a separate advertiser data structure may be employed to store information related to respective advertisers.

FIG. 6 shows an AIS component 600 receiving a flow or stream of original programming 602, and providing a flow or stream of modified programming 604, according to one illustrated embodiment.

The original programming 602 is represented as a sequence of segments, of varying durations. The original programming 602 may take the form of a “live” feed, in that the original programming is being broadcasted, streamed or otherwise transmitted in real time. Each segment is illustrated as consisting of subject matter of the programming, denominated by the letter S with a subscript, or consisting of advertisement, denominated by the letter A with a subscript. The subscripts indicate the relative order, in time, of the various segments with respect to other segments in the original programming 602 of like type. The example given employs the following sequence of segments for the original programming 602:

S₁, A₁, A₂, A₃, S₂, A₄, S₃, A₅, A₆, S₄, A₇, A₈, S₅

As described herein, the AIS component 600 may insert material into the programming. For example, the AIS component 600 may replace some material from the original programming 602 with other material to be inserted. For instance, the AIS component 600 may replace some or all advertisements A₁-A₈ from the original programming 602 with other advertisements.

The resulting or modified programming 604 is represented as a sequence of segments, of varying durations. Each segment is illustrated as consisting of subject matter of the programming, denominated by the letter S with a subscript, or consisting of inserted advertisement, denominated by the letter I with a subscript. The subscripts indicate the relative order, in time, of the various segments with respect to other segments in the resulting or modified programming 604 of like type. The example given employs the following sequence of segments for the resulting or modified programming 604:

S₁, I₁, I₂, I₃, I₄, S₂, I₅, I₆, S₃, I₇, I₈, I₉, S₄, I₁₀, S₅

The resulting or modified programming 604 is preferably provided concurrently with the broadcasting, streaming or other transmission of the original programming 602, even more preferably with little difference in time between respective or corresponding segments (i.e., little or no time lag or lead).

Notably, the AIS component 600 has replaced the advertisements A₁-A₈ in the original programming 602 with new material, for instance, new advertisements I₁-I₁₀. In some instances, one or more advertisements A₁-A₈ have been replaced with a larger number of inserted or replacement advertisements I₁-I₁₀. For example, advertisements A₁-A₃ are replaced with inserted, new or replacement advertisements I₁-I₄. Such may be in response to the AIS component 600, or some other component (e.g., advertising network server computing system 112 of FIG. 1) determining that higher revenue will result by the change. In some instances, one or more advertisements A₁-A₈ have been replaced with a smaller number of inserted, new or replacement advertisements I₁-I₁₀. For example, original advertisements A₇-A₈ are replaced with inserted, new or replacement advertisements I₁₀. Such may be in response to the AIS component 600, or some other component (e.g., advertising network server computing system 112 of FIG. 1) determining that higher revenue will result by the change.

While not drawn to scale, a comparison of the lengths of various segments between the original programming 602 and the resulting or modified programming 604 illustrates that the length or duration of individual inserted material (e.g., inserted, new or replacement advertisements I₁-I₁₀) may be longer or shorter than the length of individual original material (e.g., original advertisements A₁-A₈). Further, in some instances the length or duration of an advertising block in the resulting or modified programming 604 may match the corresponding advertising block in the original programming 602. For example, the length of the inserted material I₁-I₄ matches the length or duration of the advertisement block A₁-A₃ of the original programming. In other instances, the length or duration of an advertising block in the resulting or modified programming 604 may not match the corresponding advertising block in the original programming 602. For example, the length of the inserted material I₁₀ in the resulting or modified programming 604 does not match the length or duration of the advertisement block A₆-A₇ of the original programming 602. Often the length or durations of the individual segments of the subject matter segments S₁-S₅ will not vary between the original programming 602 and the resulting or modified programming 604. However, in some instances the length or durations of one or more individual subject matter segments S₁-S₅ of the resulting or modified programming 604 will vary from that of the original programming 602.

FIG. 6 provides an example to explain some of the concepts discussed herein in more concrete terms, but is purely for illustrative purposes and is in no way intended to be limiting. For example, programming may have different distributions of segments, with or without advertising. Additionally, segments may be divided into sub segments, and sub segments may be further divided.

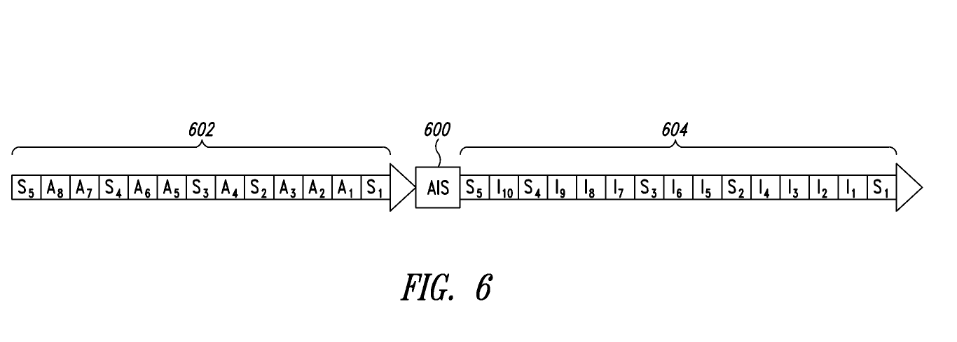

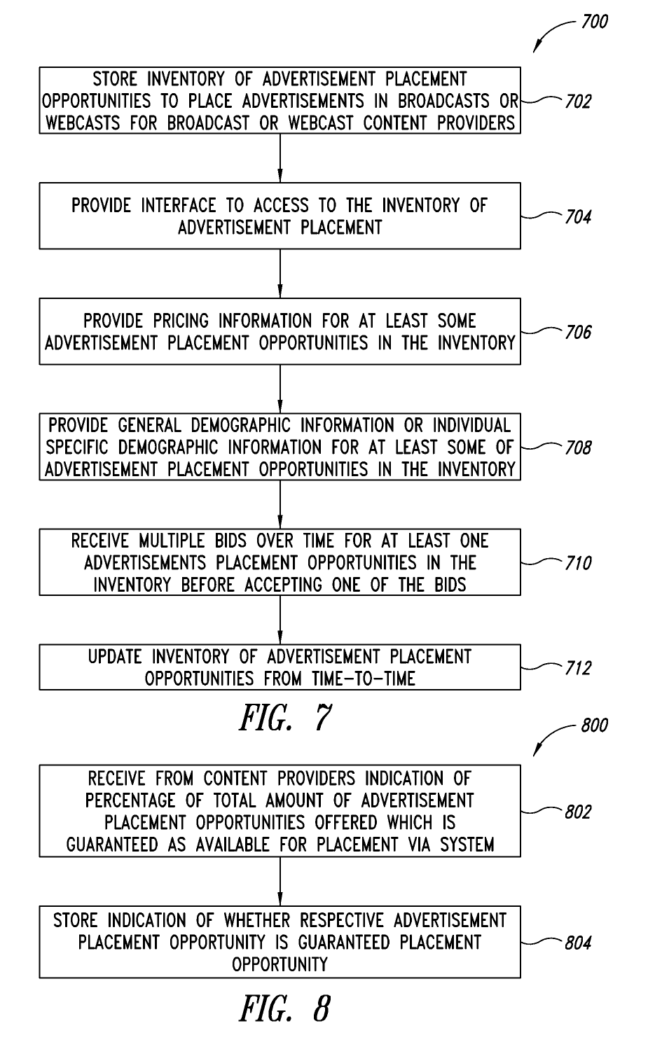

FIG. 7 shows a method 700 of operating an advertising network server computer system, according to one illustrated embodiment.

At 702, an advertising network server computer system stores to at least one nontransitory computer-readable storage medium an inventory of advertisement placement opportunities to place advertisements in at least one of a number of broadcasts or a number or Webcasts for each of a plurality of at least one of broadcast or Webcast content providers that transmit the broadcasts or the Webcasts. The advertisement placement opportunities and related information may be supplied via one or more content providers.

At 704, the advertising network server computer system implements an interface that provides access to the inventory of advertisement placement.

At 706, the advertising network server computer system provides pricing information for at least some of the advertisement placement opportunities in the inventory of advertisement placement opportunities via the interface.

At 708, the advertising network server computer system provides at least one of general demographic information or individual specific demographic information in conjunction with the pricing information for at least some of the advertisement placement opportunities in the inventory of advertisement placement opportunities, via the interface.

Optionally at 710, the advertising network server computer system receives multiple bids or offers over time for at least one of the advertisement placement opportunities in the inventory of advertisement placement opportunities, before accepting one of the bids or offers.

At 712, the advertising network server computer system updates the inventory of advertisement placement opportunities from time-to-time to reflect advertisement placement opportunities no longer available and new advertisement placement opportunities that are available.

The method 700 may allow advertisers, potential advertisers, their representatives, as well as other advertising networks to view advertisement placement opportunities and pricing, as well as reserve, bid or offer on the opportunities or place advertisements. Pricing may be represented in various ways. For example, pricing may include a then current offering price, which may be updated to reflect offers or bids for the respective advertisement placement opportunities. Pricing may include a minimum or reserve price, below which the respective advertising placement opportunity will not be sold via the system. Pricing may include a “buy it now” price, which is a price at which a buyer may be guaranteed to receive the respective advertisement placement opportunities if the buyer agrees to pay that price, even if another potential buyer later offers a higher price. Pricing information may be represented in various forms, such as cost per thousand (i.e., CPM) or cost per rating point (i.e., CPP), cost per acquisition (i.e., CPA), or any other of the forms commonly used in the industry. Pricing may also represent exchanges of value other than currency, for example agreements that would be denominated as barters.

The may implement dynamic pricing, which may vary price (e.g., CPM) based on a current or present value of one or more variables. For example, a minimum or reserve price, represented for instance in CPM, may vary based on geographical proximity of an audience to a target location, for example increasing with increasing proximity or decreasing with decreasing proximity. Pricing may be automatically varied basted on other dynamic external factors. For example, weather may affect pricing. For instance, sunny weather may increase the pricing for car wash advertisements or ice cream, while rainy weather may increase the pricing for foul weather gear and umbrellas. Mortgage rates may affect the pricing of advertisements related to lenders or mortgage brokers, for example pricing increasing as mortgage rates fall. Stock prices may affect pricing of advertisements for investment firms. Such relationship may, or may not, be linear mathematical relationships, and may or may not be direct relationships or inverse relationships. The running of advertisements may be preconditioned upon occurrence or prediction of certain external conditions or events, for example certain weather conditions (e.g., sunny, rainy, severe storm) or other conditions (e.g., mortgage rates below a defined default value, or change in rate greater than a defined amount). Such may be further limited to the occurrence of the trigger condition happening in a specific geographic area, for example a geographic area in which the audience resides.

The method 700 may allow content providers to automatically advertise their inventory of advertisement time in a coherent fashion that permits effective realization of such. The advertising network server computer system to some respects functions as a clearinghouse for advertising inventory of the content providers.

FIG. 8 shows a method 800 of operating an advertising network server computer system, according to one illustrated embodiment. The method 800 may be employed in performing the method 700 (FIG. 7).

At 802, an advertising network server computer system receives a signal from one of the broadcast or Webcast content providers that includes an indication of a percentage of a total amount of advertisement placement opportunities offered by the respective broadcast or Webcast content provider which the respective broadcast or Webcast content provider guarantees as available for placement via the specific advertiser network. Notably, there may be more than one advertiser networks, and this may allow content providers to foster competition between advertiser networks and advertisers.

At 804, in response to the received signal, the advertising network server computer system stores an indication identifying a number of the advertisement placement opportunities as a guaranteed placement opportunity. Such may, for example, be stored to an advertising placement opportunity related data structure.

FIG. 9 shows a method 900 of operating an advertising network server computer system, according to one illustrated embodiment. The method 800 may be employed in performing the method 700 (FIG. 7).

At 902, an advertising network server computer system receives a signal from at least one of the broadcast or Webcast content providers that includes an indication of at least one of a cap to or a maximum percentage of a total amount of advertisement placement opportunities offered by the respective broadcast or Webcast content provider which the advertiser network may sell or offer.

At 904, in response to the signal the advertising network server computer system limits a total number of the advertisement placement opportunities to place advertisements offered via the advertiser network.

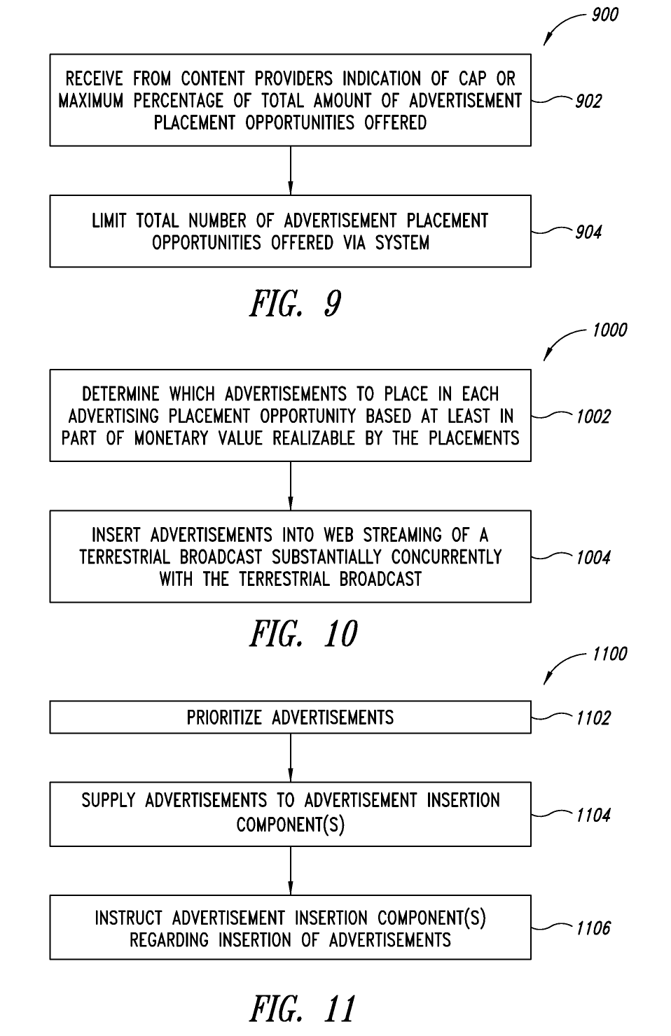

FIG. 10 shows a method 1000 of operating an insertion system component to insert material into an alternate stream of programming, according to one illustrated embodiment. The method 1000 may insert new or replacement advertisements identified or placed via the methods 700, 800 and/or 900 (FIGS. 7-9, respectively).

At 1002, for each of at least some of the advertisement placement opportunities in one of the broadcasts or Webcasts, a material (e.g., advertising) insertion system component determines or selects which of a plurality of advertisements to place in each of a plurality of the advertising opportunities based at least in part on a monetary value realizable by the placements of the advertisements. As explained above, the determination or selection may additionally, or alternatively be based on one or more other factors or parameters. For example, the determination or selection may be based at least in part on format, language, general demographic or specific demographic information, and/or duration or length of material.

As also explained above, the advertising insertion component or subsystem 306 may be responsive at least in part to one or more advertiser network server computer systems 112 (FIG. 1). For example, the material for the insertion material inventory may be provided via the advertiser network server computer systems 112. Additionally, or alternatively, the advertiser network server computer systems 112 may indicate which advertisements to insert into which advertisement placement opportunities. Such may be performed, for example, based on demographic information regarding the audience, demographic information regarding the target audience for the advertisement, and/or maximize advertising revenue generated by the advertisement insertions. Such may be responsive to a prioritization scheme or hierarchy.

At 1004, the material insertion system component inserts advertisements into a Web streaming of a terrestrial broadcast of a broadcast content provider, substantially concurrently with the terrestrial broadcast.

FIG. 11 shows a method 1100 of operating either an advertiser network server computer system or an advertisement insertion component or system, according to one illustrated embodiment.

At 1102, the advertiser network server computer system or the advertisement insertion component prioritizes advertisements for insertion or placement into Web streaming of content, for instance Web streaming of radio or television broadcast content.

Various prioritization schemes or hierarchies may be employed. For example, highest priority may be given to already sold or bartered advertisements. Next highest priority may be given to advertising placements booked by one or more advertisement placement networks. Guaranteed advertisement placement opportunities may take precedence over non-guaranteed ones. The next highest priority may be given to advertisements sold by a station or local broadcaster or other content provider. Priority may then be based on various dynamic factors and or dynamic pricing. For example, certain reservations, requests or offers for advertising placement opportunities may produce higher revenue than other reservations, requests or offers for the same advertising placement opportunities. Such may, for example occur due to some external condition, even or circumstance. The preference scheme or hierarchy may automatically account for dynamic changes in pricing, inserting or causing the insertion of advertising the results in the highest revenue, or highest cumulative revenue for the content provider and/or advertisement placement network. Lowest in priority may, for example, include non-revenue producing, for instance public service announcements or a content providers own advertisements for its own content.

Optionally at 1104, the advertiser network server computer system transmits or causes to be transmitted, selected advertisements or advertising material to the advertisement insertion component(s). Such may be delivered electronically or in some other form (e.g., non-transitory computer-readable media).

At 1106, the advertiser network server computer system causes the advertisement insertion component(s) to insert the advertisements into the Web streaming of the content. As noted above, the insertion may be performed in order of a prioritization scheme or hierarchy, for example to maximize revenue generation for the content provider. Also as discussed above, the advertisement insertion component(s) may insert the advertisements to substitute for other advertisements in the content. Such may allow insertion of more targeted advertisements or insertion of advertisement that will produce a higher revenue for the content provider. The advertisements may be inserted into a real time transmission (e.g., live Web streaming) of the content, for example content being broadcast in real time, whether the content was taped or live.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other systems, not necessarily the exemplary system generally described above.

For instance, topologies other than those illustrated and/or described may be employed.

For example, a first topology may allow advertisement insertion to be accomplished before or upstream of an encoder. In such a topology, a content provider automation system may provide a feed of content and advertisements to an advertisement insertion component. The feed may, for instance, take the form of a feed of a terrestrial broadcast, for example a live feed (i.e., concurrent with the actual broadcasting, whether the content in the broadcast is prerecorded or live). The advertisement insertion component may detect the start and/or stop of advertisements in the feed, and substitute replacement or substitute advertisements in place of the advertisements in the feed. The advertisement insertion component provides the content with the substitute replacement or substitute advertisements to an encoder, which encodes such and provides the encoded results to one or more media servers for delivery to an audience (e.g., Web streaming). The one or more media servers may, for example, form part of, or be communicatively coupled with, a content delivery network (CDN). As previously explained, the replacement or substitute advertisements may be targeted to the intended audience and/or may be selected based on various external factors, as well as to maximize revenue generation.

Also for example, a second topology may allow advertisement insertion to be accomplished on a client side, after or downstream of an encoder and/or media server. In such a topology, a content provider automation system may provide a feed of content and advertisements to an advertisement insertion component. The feed may, for instance, take the form of a feed of a terrestrial broadcast, for example a live feed (i.e., concurrent with the actual broadcasting, whether the content in the broadcast is prerecorded or live). The advertisement insertion component may detect the start and/or stop of advertisements in the feed, and insert, or even substitute, metadata specifying replacement or substitute advertisements to retrieve and play in place of the advertisements in the feed. The advertisement insertion component provides the content with the inserted metadata to an encoder, which encodes such and provides the encoded results to one or more media servers for delivery to an audience (e.g., Web streaming). The one or more media servers may, for example, form part of, or be communicatively coupled with, a content delivery network (CDN).

When played on a client device, the client device is triggered by, or otherwise employs, the metadata to retrieve replacement or substitute advertisements to replace or substitute for the original advertisements in the feed. The client device may retrieve the replacement or substitute advertisements from a variety of different sources, for instance, an advertiser network server computer system, an advertising network, and/or a third party advertisement aggregator. As previously explained, the replacement or substitute advertisements may be targeted to the intended audience and/or may be selected based on various external factors, as well as to maximize revenue generation. In this respect, the metadata may simply specify characteristics of the advertisement section which is being replaced, for example specifying a start time, stop time, duration, language, and/or demographic market. A component on the client side, for example operating on a client device (e.g., computer, Smartphone, personal digital assistance, tablet device) may use the information, as well as additional information specific to the user to identify and/or retrieve the replacement or substitute advertisements. For example, the client side component may use information regarding a user's browsing habits or shopping habits stored in one or more cookies on the user device to identify and/or retrieve the replacement or substitute advertisements. Additionally, or alternatively, the client side component may use other information for example a current location (e.g., via GPS receiver or cellular triangulation), actual or predicted weather based on current location, to identify and/or retrieve the replacement or substitute advertisements. Alternatively, the metadata may directly specify the replacement or substitute advertisements or specify a location (i.e., logical address) for retrieving the replacement or substitute advertisements.

As a further example, a third topology may allow advertisement insertion to be accomplished by a media server, after or downstream of an encoder and before or upstream of client devices. In such a topology, a content provider automation system may provide a feed of content and advertisements to an advertisement insertion component. The feed may, for instance, take the form of a feed of a terrestrial broadcast, for example a live feed (i.e., concurrent with the actual broadcasting, whether the content in the broadcast is prerecorded or live). The advertisement insertion component may detect the start and/or stop of advertisements in the feed, and insert, or even substitute, metadata specifying replacement or substitute advertisements to retrieve and play in place of the advertisements in the feed. The advertisement insertion component provides the content with the inserted metadata to an encoder, which encodes such and provides the encoded results to one or more media servers for delivery to an audience (e.g., Web streaming). The one or more media servers may, for example, form part of, or be communicatively coupled with, a content delivery network (CDN).

The media servers are triggered by, or otherwise employ, the metadata to retrieve replacement or substitute advertisements to replace or substitute for the original advertisements in the feed. The media server(s) may retrieve the replacement or substitute advertisements from a variety of different sources, for instance, an advertiser network server computer system, an advertising network, and/or a third party advertisement aggregator. As previously explained, the replacement or substitute advertisements may be targeted to the intended audience and/or may be selected based on various external factors, as well as to maximize revenue generation. In this respect, the metadata may simply specify characteristics of the advertisement section which is being replaced, for example specifying a start time, stop time, duration, language, and/or demographic market. The media server(s) may, for example, use the information, as well as additional information specific to the targeted end user to identify and/or retrieve the replacement or substitute advertisements. For example, the media server(s) may use information regarding a user's browsing habits or shopping habits stored in one or more cookies on the user device or elsewhere to identify and/or retrieve the replacement or substitute advertisements. Additionally, or alternatively, the media server(s) may use other information for example a current location (e.g., forwarded by a client device) and/or actual or predicted weather based on current location, to identify and/or retrieve the replacement or substitute advertisements. Alternatively, the metadata may directly specify the replacement or substitute advertisements or specify a location (i.e., logical address) for retrieving the replacement or substitute advertisements.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs) or programmable gate arrays. However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Various methods and/or algorithms have been described. Some or all of those methods and/or algorithms may omit some of the described acts or steps, include additional acts or steps, combine acts or steps, and/or may perform some acts or steps in a different order than described. Some of the method or algorithms may be implemented in software routines. Some of the software routines may be called from other software routines. Software routines may execute sequentially or concurrently, and may employ a multi-threaded approach.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as portable disks and memory, hard disk drives, CD/DVD ROMs, digital tape, computer memory, and other non-transitory computer-readable storage media.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including but not limited to U.S. Provisional Application Ser. No. 61/561,186, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An automation placement system to automate advertisement placement in broadcasts or Webcasts, the automation placement system comprising:
at least one nontransitory computer-readable storage medium that stores an inventory of advertisement placement opportunities to place advertisements in at least one of a number of broadcasts or a number or Webcasts for each of a plurality of at least one of broadcast or Webcast content providers that transmit the broadcasts or the Webcasts, respectively; and
at least one processor communicatively coupled to the at least one nontransitory computer-readable storage medium and which implements an interface that provides access to the inventory of advertisement placement and that updates the inventory of advertisement placement opportunities from time-to-time to reflect advertisement placement opportunities no longer available and new advertisement placement opportunities that are available, the at least one processor further communicatively coupled to cause a number of advertisement insertion components to insert a number of advertisements into a Web streaming of at least one of the terrestrial broadcasts or the Webcast of the at least one broadcast or Webcast content provider during the terrestrial broadcast or the Webcast.

2. The automation placement system of claim 1 wherein the inventory of advertisement placement opportunities to place advertisements stored by the at least one nontransitory computer-readable medium includes, for each of at least some of the advertisement placement opportunities, an indication of whether the respective advertisement placement opportunity is a guaranteed placement opportunity for a defined advertisement network, where each guaranteed placement opportunity for an advertisement ensures that the advertisement network has an exclusive right for the respective advertisement placement opportunity from the at least one broadcast or Webcast content provider.

3. The automation placement system of claim 2 wherein the inventory of advertisement placement opportunities to place advertisements stored by the at least one nontransitory computer-readable medium includes, for each of at least some of the advertisement placement opportunities, an indication of whether the respective advertisement placement opportunity is a nonguaranteed placement opportunity, where each nonguaranteed placement opportunity for an advertisement available from at least one source other than the defined advertisement network.

4. The automation placement system of claim 1 wherein the at least one processor identifies a number of the advertisement placement opportunities to place advertisements as guaranteed placement opportunities, in response to receipt of a signal from one of the broadcast or Webcast content providers that includes an indication of a percentage of a total amount of advertisement placement opportunities offered by the respective broadcast or Webcast content provider which the respective broadcast or Webcast content provider guarantees to a defined advertisement network as available for placement thereby via the automation placement system.

5. The automation placement system of claim 1 wherein the at least one processor limits a total number of the advertisement placement opportunities to place advertisements offered via the automation placement system, in response to receipt of a signal from one of the broadcast or Webcast content providers that includes an indication of at least one of a cap to or a maximum percentage of a total amount of advertisement placement opportunities offered by the respective broadcast or Webcast content provider to a defined advertisement network.

6. The automation placement system of claim 1 wherein the at least one processor provides pricing information for at least some of the advertisement placement opportunities in the inventory of advertisement placement opportunities.

7. The automation placement system of claim 6 wherein the at least one processor provides at least one of general population demographic information or individual specific demographic information in conjunction with the pricing information for at least some of the advertisement placement opportunities in the inventory of advertisement placement opportunities.

8. The automation placement system of claim 7 wherein the at least one processor receives multiple offers over time for at least one of the advertisement placement opportunities in the inventory of advertisement placement opportunities, before accepting one of the offers.

9. The automation placement system of claim 7 wherein the at least one processor receives multiple offers from a plurality of advertising networks over time for at least one of the advertisement placement opportunities in the inventory of advertisement placement opportunities, before accepting one of the offers.

10. The automation placement system of claim 6 wherein the at least one processor provides the pricing information for at least some of the advertisement placement opportunities in the inventory of advertisement placement opportunities in the form of a current offer price and a guaranteed purchase price which guarantees the respective advertisement placement opportunity.

11. The automation placement system of claim 6 wherein the at least one processor provides the pricing information for at least some of the advertisement placement opportunities in the inventory of advertisement placement opportunities in the form of a dynamically adjusted price that is based on at least one external condition or event.

12. The automation placement system of claim 1 wherein the at least one processor provides at least one of general population demographic information or individual specific demographic information for at least some of the advertisement placement opportunities in the inventory of advertisement placement opportunities.

13. The automation placement system of claim 1 wherein the at least one processor provides pricing information in terms of a unit number of impressions to each of a number of advertising networks for at least some of the advertisement placement opportunities in the inventory of advertisement placement opportunities which exceed an amount of advertisement placement opportunities that is directly allocated for placement solely via the automation placement system by respective ones of the broadcast or Webcast content providers.

14. The automation placement system of claim 1 wherein for each of at least some of the advertisement placement opportunities in one of the broadcasts or Webcasts, the at least one processor determines which of a plurality of advertisements to place in each of a plurality of the advertising opportunities based at least in part on a monetary value realizable by the placements of the advertisements.

15. The automation placement system of claim 1 wherein each of at least some of the advertisement placement opportunities are respective ones of a number of commercial breaks in a Web streaming of a terrestrial broadcast, and the at least one processor determines which of a plurality of advertisements to place in the commercial breaks in the Web streaming.

16. The automation placement system of claim 15 wherein the at least one processor determines which of a plurality of advertisements to place in the commercial breaks in the Web streaming based at least in part on a monetary value of the advertisement placements.

17. The automation placement system of claim 15 wherein the at least one processor determines to place a first number of relatively short advertisements in one of the commercial breaks in the Web streaming, and the first number is larger than a number of advertisements in the same one of the commercial breaks in the terrestrial broadcast.

18. The automation placement system of claim 1, further comprising:
at least one of the advertisement insertion components, each of the at least one of the advertisement insertion components including at least one nontransitory processor-readable storage and at least one insertion component processor communicatively coupled to the at least one nontransitory processor-readable medium, and which inserts advertisements into the Web streaming of the terrestrial broadcast of the broadcast content provider which is substantially concurrent with the terrestrial broadcast.

19. The automation placement system of claim 1 wherein the at least one processor prioritizes advertisements based on a prioritization schedule which at least partially accounts for revenue generation.

20. A method of operating an automation placement system to automate advertisement placement in broadcasts or Webcasts, the method comprising:
storing to at least one nontransitory computer-readable storage medium an inventory of advertisement placement opportunities to place advertisements in at least one of a number of broadcasts or a number or Webcasts for each of a plurality of at least one of broadcast or Webcast content providers that transmit the broadcasts or the Webcasts, respectively; and
providing an interface by at least one processor that provides access to the inventory of advertisement placement;
updating the inventory of advertisement placement opportunities from time-to-time by the at least one processor to reflect advertisement placement opportunities no longer available and new advertisement placement opportunities that are available; and
sending at least one signal that causes at least one of a number of advertisement insertion components to insert a number of advertisements into a Web streaming of at least one of the broadcasts or the Webcasts of the at least one broadcast or Webcast content provider during the broadcast or the Webcast.

21. The method of claim 20 wherein storing the inventory of advertisement placement opportunities to place advertisements to the at least one nontransitory computer-readable medium includes, for each of at least some of the advertisement placement opportunities, storing an indication of whether the respective advertisement placement opportunity is a guaranteed placement opportunity for a defined advertisement network, where each guaranteed placement opportunity is allocated solely to the defined advertisement network for offer thereby to a plurality of potential advertisers.

22. The method of claim 21 wherein storing the inventory of advertisement placement opportunities to place advertisements to the at least one nontransitory computer-readable medium includes, for each of at least some of the advertisement placement opportunities, storing an indication of whether the respective advertisement placement opportunity is a nonguaranteed placement opportunity, where each nonguaranteed placement opportunity for an advertisement indicates that the respective advertisement placement opportunity is available from at least one source in addition to the defined advertisement network.

23. The method of claim 20, further comprising:
receiving a signal from one of the broadcast or Webcast content providers by the at least one processor, that includes an indication of a percentage of a total amount of advertisement placement opportunities offered by the respective broadcast or Webcast content provider which the respective broadcast or Webcast content provider guarantees to a defined advertisement network as available for placement thereby via the automation placement system; and
identifying as guaranteed placement opportunities by the at least one processor, a number of the advertisement placement opportunities to place advertisements in response to the received signal.

24. The method of claim 20, further comprising:
in response to receipt of a signal from one of the broadcast or Webcast content providers that includes an indication of at least one of a cap to or a maximum percentage of a total amount of advertisement placement opportunities offered by the respective broadcast or Webcast content provider, limiting by the at least one processor a total number of the advertisement placement opportunities to place advertisements offered to a defined advertisement network.

25. The method of claim 20, further comprising:
providing pricing information to the at least one processor for at least some of the advertisement placement opportunities in the inventory of advertisement placement opportunities.

26. The method of claim 25, further comprising:
providing at least one of general demographic information or individual specific demographic information in conjunction with the pricing information for at least some of the advertisement placement opportunities in the inventory of advertisement placement opportunities.

27. The method of claim 26, further comprising:
receiving by the at least one processor multiple offers over time for at least one of the advertisement placement opportunities in the inventory of advertisement placement opportunities, before accepting one of the offers.

28. The method of claim 26, further comprising:
receiving by the at least one processor multiple offers from a plurality of advertising networks over time for at least one of the advertisement placement opportunities in the inventory of advertisement placement opportunities, before accepting one of the offers.

29. The method of claim 25 wherein providing pricing information for at least some of the advertisement placement opportunities in the inventory of advertisement placement opportunities includes providing a current offer price and a guaranteed purchase price which guarantees the respective advertisement placement opportunity.

30. The method of claim 25 wherein providing pricing information for at least some of the advertisement placement opportunities in the inventory of advertisement placement opportunities includes dynamically providing the pricing information in the form of a dynamically adjusted price that is based on actual or a predicted occurrence of at least one external condition or event.

31. The method of claim 20 wherein the at least one processor provides at least one of general population demographic information or individual specific demographic information for at least some of the advertisement placement opportunities in the inventory of advertisement placement opportunities.

32. The method of claim 20, further comprising:
providing by the at least one processor pricing information in terms of a unit number of impressions to each of a number of advertising networks for at least some of the advertisement placement opportunities in the inventory of advertisement placement opportunities which exceed an amount of advertisement placement opportunities that is directly allocated for placement solely via the method by respective ones of the broadcast or Webcast content providers.

33. The method of claim 20, further comprising:
for each of at least some of the advertisement placement opportunities in one of the broadcasts or Webcasts, determining by the at least one processor which of a plurality of advertisements to place in each of a plurality of the advertising opportunities based at least in part on a monetary value realizable by the placements of the advertisements.

34. The method of claim 20 wherein each of at least some of the advertisement placement opportunities are respective ones of a number of commercial breaks in a Web streaming of a terrestrial broadcast, and further comprising:
determining by the at least one processor which of a plurality of advertisements to place in the commercial breaks in the Web streaming.

35. The method of claim 34 wherein determining which of a plurality of advertisements to place in the commercial breaks in the Web streaming includes determining which of the plurality of advertisements to place in the commercial breaks in the Web streaming based at least in part on a monetary value of the advertisement placements.

36. The method of claim 34 wherein determining which of a plurality of advertisements to place in the commercial breaks in the Web streaming includes determining to place a first number of relatively short advertisements in one of the commercial breaks in the Web streaming, and the first number is larger than a number of advertisements in the same one of the commercial breaks in the terrestrial broadcast.

37. The method of claim 20, further comprising:
inserting advertisements by at least one of the advertisement insertion components into at least one Web streaming of a terrestrial broadcast of a broadcast content provider substantially concurrently with the terrestrial broadcast.

38. The method of claim 20, further comprising:
prioritizing a number of the advertisements based on a prioritization schedule which at least partially accounts for an identity of an entity through which an offer for a respective one of the advertisement placement opportunities was generated.

39. The method of claim 20, further comprising:
replacing an advertising opportunity in a first one of the broadcasts or the Webcasts with a first advertisement in a first Web streaming of the content of the first one of the broadcasts or the Webcasts to a first recipient; and
replacing the advertising opportunity in the first one of the broadcasts or the Webcasts with a second advertisement in the first Web streaming of the content of the first one of the broadcasts or the Webcasts to a second recipient, the second advertisement different from the first advertisement.
